(19) United States
(12) Patent Application Publication
(10) Pub. No.: US 2017/0214895 A1
(43) Pub. Date: Jul. 27, 2017

(54) PROJECTION APPARATUS, PROJECTION METHOD, AND STORAGE MEDIUM

(71) Applicant: CANON KABUSHIKI KAISHA, Tokyo (JP)

(72) Inventor: Masaki Fujioka, Chiba-shi (JP)

(21) Appl. No.: 15/410,376

(22) Filed: Jan. 19, 2017

(30) Foreign Application Priority Data
Jan. 21, 2016 (JP) 2016-009586

(51) Int. Cl. H04N 9/31

(52) U.S. Cl. CPC H04N 9/3188; H04N 9/3185; H04N 9/3147

(57) ABSTRACT

A projector includes an image input unit for obtaining a first input image and a second input image, an optical system control unit for projecting a first projection image based on the first input image and a second projection image based on the second input image on a screen, and a CPU causing a projection unit to project the first projection image and the second projection image in different layouts depending on whether the transition is one from a state of projecting the first projection image to a state of projecting the first projection image and the second projection image simultaneously by means of the projection apparatus alone or one from a state of projecting the first projection image to a state of projecting the first projection image and the second projection image simultaneously by means of the projection apparatus in cooperation with a different projector.

### BACKGROUND

Field of the Disclosure

The present disclosure relates to a projection apparatus and a projection method for projecting an image on a screen or the like.

Description of the Related Art

Conventionally known is a picture-out-picture display method in which a plurality of images are arranged and displayed on one projection screen when the plurality of images are input.

For example, Japanese Patent Laid-Open No. 2011-81188 discloses a projector for projecting a plurality of images on an equal screen simultaneously.

Also known is a method for performing multiple projection with use of a plurality of projectors for large screen display.

For example, Japanese Patent Laid-Open No. 2008-70397 discloses a method for achieving large screen display by dividing one image to generate a plurality of divided images and causing a plurality of projectors to respectively display the divided images.

However, in a case in which, while one image is being projected in a multiple manner with use of a plurality of projectors, one of the projectors is in a state of receiving two images, the projector in which the two images are input shrinks the image that is being projected and projects side by side the image that is being projected and another image that is to be newly projected. Another projector projects the image that is being projected without shrinking the image. That is, while the image that is being projected is shrunk in the projector projecting the plurality of images, the image that is being projected is not shrunk in the other projector for use in the multiple projection. This causes a problem in which misalignment occurs between adjacent projected images respectively projected by the plurality of projectors.

### SUMMARY

An aspect of the present disclosure is to solve all or at least one of the above problems.

Also, according to an aspect of the present disclosure, a projection apparatus for projecting an image includes a projection unit, a processor, and a memory having stored thereon instructions that when executed by the processor, cause the processor to obtain a first input image and a second input image, project a first projection image based on the first input image and a second projection image based on the second input image on a screen by means of the projection unit, and in a case of transition from a state of projecting the first projection image to a state of projecting the first projection image and the second projection image simultaneously, perform control so that the projection unit may project the first projection image and the second projection image in different layouts from each other depending on whether the transition is one from a state of projecting the first projection image to a state of projecting the first projection image and the second projection image simultaneously by means of the projection apparatus alone or one from a state of projecting the first projection image to a state of projecting the first projection image and the second projection image simultaneously by means of the projection apparatus in cooperation with a different projection apparatus.

Further features of the present disclosure will become apparent from the following description of exemplary embodiments (with reference to the attached drawings).

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the disclosure.

FIG. 1 illustrates a configuration of a projection system according to one or more aspects of the present disclosure.

FIGS. 2A and 2B illustrate transition operations to a state of projecting a plurality of images simultaneously according to one or more aspects of the present disclosure.

FIG. 3 illustrates a configuration of a projector according to one or more aspects of the present disclosure.

FIG. 4 illustrates an example of a brightness adjustment coefficient according to one or more aspects of the present disclosure.

FIGS. 5A and 5B illustrate display methods according to one or more aspects of the present disclosure.

FIG. 6 illustrates a picture-out-picture image according to one or more aspects of the present disclosure.

FIGS. 7A to 7D illustrate operations of a display region changing unit according to one or more aspects of the present disclosure.

FIG. 8 is a flowchart illustrating basic operations of the projector according to one or more aspects of the present disclosure.

FIG. 9 is a flowchart illustrating operations at the time of multiple projection according to one or more aspects of the present disclosure.

FIGS. 10A and 10B are flowcharts illustrating operations of the projector 100 and a projector 200 in a second embodiment, respectively.

FIGS. 11A to 11C illustrate a position in which the projector projects an image according to one or more aspects of the present disclosure.

FIGS. 12A and 12B illustrate operations in a modification example according to one or more aspects of the present disclosure.

FIGS. 13A and 13B illustrate connection methods of the projector 100 and the projector 200 in a third embodiment.

FIGS. 14A and 14B illustrate processing for dividing an image according to one or more aspects of the present disclosure.

FIG. 15 is a flowchart illustrating operations in which a second input image is projected according to one or more aspects of the present disclosure.

FIGS. 16A and 16B illustrate image processing in the third embodiment according to one or more aspects of the present disclosure.

### DESCRIPTION OF THE EMBODIMENTS

Various exemplary embodiments, features, and aspects of the disclosure will be described in detail below with reference to the drawings.

<First Embodiment>

[Overview of Projection System S]

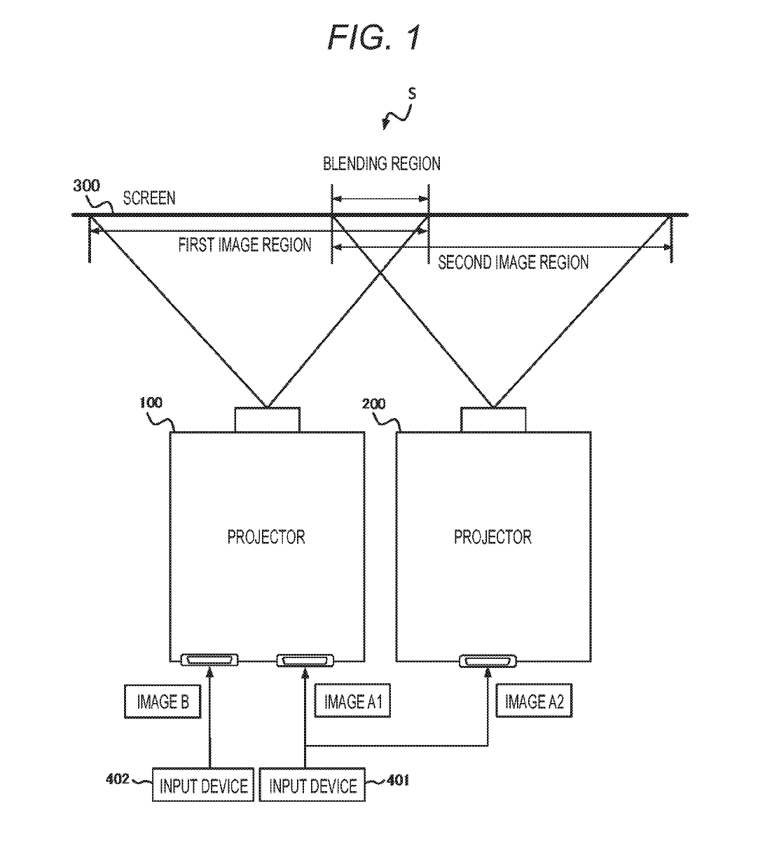

FIG. 1 illustrates a configuration of a projection system S according to a first embodiment. The projection system S can project on a screen 300 images based on image signals input from an input device 401 and an input device 402 with use of two projectors consisting of a projector 100 and a projector 200. The projector 100 and the projector 200 have similar functions, and a configuration of the projector 100 will mainly be described in the present specification.

The projector 100 is a liquid crystal projector, for example. The projector 100 controls light transmittance of liquid crystal elements in accordance with image signals input from the input device 401 and the input device 402 and projects light from a light source passing through the liquid crystal elements on the screen to provide a user with an image.

Each of the input device 401 and the input device 402 is an image signal source such as a computer. The input device 401 and the input device 402 transmit image signals to the projector 100 and the projector 200 via image cables. Each of the input device 401 and the input device 402 may be an arbitrary device such as a personal computer, a camera, a mobile phone, a smartphone, an HDD recorder, and a game machine as long as the device can output image signals.

The projector 100 and the projector 200 receive image signals transmitted by the input device 401 and project images based on the received image signals on the screen 300 to display one integrated large screen image. As illustrated in FIG. 1, a first image region on which the projector 100 displays an image and a second image region on which the projector 200 displays an image overlap with each other in a blending region, in which edge blending is performed.

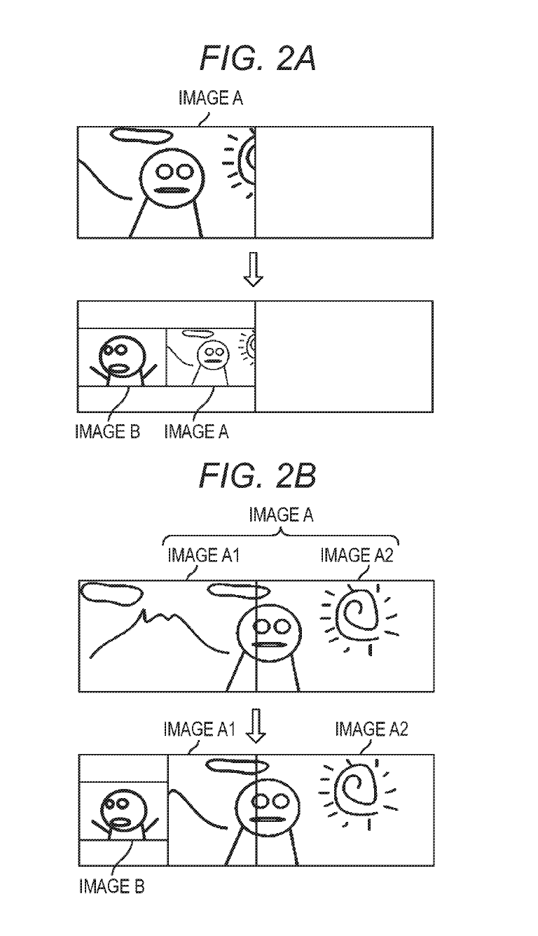

FIGS. 2A and 2B illustrate transition operations from a state of projecting an image A (first projection image) to a state of projecting the image A and an image B (second projection image) simultaneously. FIG. 2A illustrates transition operations from the state of projecting the image A to the state of projecting the image A and the image B simultaneously by means of the projector 100 alone. FIG. 2B illustrates transition operations from the state of projecting the image A to the state of projecting the image A and the image B simultaneously by means of the projector 100 in cooperation with the projector 200. The projector 100 projects the image A and the image B on the screen 300 in different layouts from each other in the case illustrated in FIG. 2A and in the case illustrated in FIG. 2B. Meanwhile, in the state in FIG. 2A, the projector 100 displays a partial region of the image A input from the input device 401.

In the case of the transition from the state of projecting the image A to the state of projecting the image A and the image B simultaneously by means of the projector 100 alone as illustrated in FIG. 2A, the projector 100 shrinks the image A and displays the image A and the image B side by side in a right-left direction. Conversely, in the case of the transition from the state of projecting the image A (an image A1 and an image A2) to the state of projecting the image A and the image B simultaneously by means of the projector 100 in cooperation with the projector 200 as illustrated in FIG. 2B, the projector 100 deletes a partial region in the image A1 located on an opposite side of the image A2 without shrinking the image A1 that is being projected. The projector 100 then projects the image B in a part of the first image region, on which the projector 100 projects an image, not edge-blended with the image A2 projected by the projector 200.

In this manner, depending on whether the projector 100 is being operated in a lone projection mode for projecting an image by means of the projector 100 alone or in a multiple projection mode for projecting an image by means of the projector 100 in cooperation with the projector 200, the projector 100 determines a layout after the state has been switched to the mode of displaying a plurality of images. Accordingly, the projector 100 can project the plurality of images appropriately both in the lone projection mode and in the multiple projection mode.

[Configuration of Projector 100]

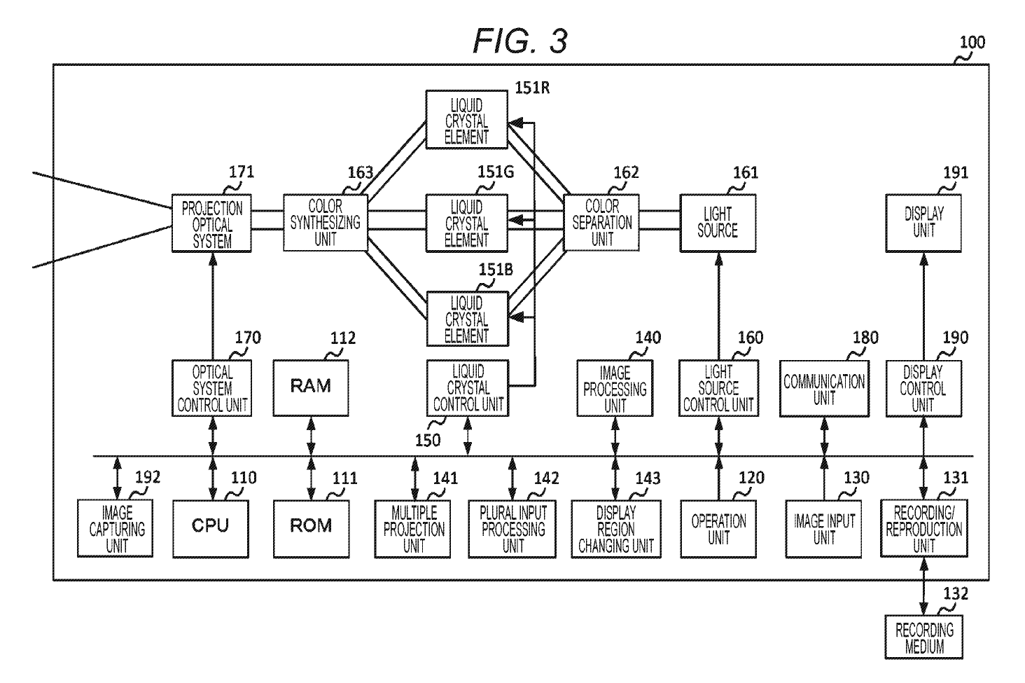

FIG. 3 illustrates a configuration of the projector 100. Since the projector 100 and the projector 200 have equal configurations, the overall configuration of the projector 100 will be described with reference to FIG. 3, and description of the configuration of the projector 200 will be omitted.

The projector 100 according to the present embodiment includes a CPU 110, a ROM 111, a RAM 112, an operation unit 120, an image input unit 130, a recording/reproduction unit 131, an image processing unit 140, a liquid crystal control unit 150, liquid crystal elements 151R, 151G, and 151B, a light source control unit 160, a light source 161, a color separation unit 162, a color synthesizing unit 163, an optical system control unit 170, a projection optical system 171, a communication unit 180, a display control unit 190, a display unit 191, and an image capturing unit 192. The projector 100 also includes a multiple projection unit 141, a plural input processing unit 142, and a display region changing unit 143 to be used to provide characteristic functions of the present embodiment. The liquid crystal control unit 150, the liquid crystal elements 151R, 151G, and 151B, the light source control unit 160, the light source 161, the color separation unit 162, the color synthesizing unit 163, the optical system control unit 170, and the projection optical system 171 function as projection units.

The CPU 110 is a control unit for controlling the respective operation blocks of the projector 100 by executing a control program stored in the ROM 111. The ROM 111 has stored therein the control program in which a processing procedure of the CPU 110 is described. The RAM 112 temporarily stores the control program and data as a working memory. The CPU 110 temporarily stores still image data and video image data received from the communication unit 180 and reproduces the respective image and video with use of the program stored in the ROM 111. The CPU 110 also receives a control signal input from the operation unit 120 or the communication unit 180 and controls the respective operation blocks of the projector 100.

The CPU 110 sets a mode in which the projector 100 is to be operated to a mode selected by a user by means of the operation unit 120. For example, the CPU 110 sets the lone projection mode, in which the projector 100 alone projects one image, or the multiple projection mode, in which the projector 100 projects one image in cooperation with the projector 200. The CPU 110 may automatically set the mode to the multiple projection mode in a case in which the communication unit 180 is connected to the projector 200.

The operation unit 120 is an acceptance unit for accepting an instruction of the user and transmits an instruction signal indicating the content of the accepted instruction to the CPU 110. For example, the operation unit 120 accepts setting of whether the projector 100 is operated in the lone projection mode or in the multiple projection mode. Examples of the operation unit 120 are a switch, a dial, and a touch panel provided on the display unit 191. The operation unit 120 may be a signal reception unit for receiving a signal from a remote control unit, for example, and may transmit a predetermined instruction signal to the CPU 110 based on the received signal.

The image input unit 130 is an obtaining unit for obtaining an image signal containing first input image data from the input device 401 and an image signal containing second input image data from the input device 402. The image input unit 130 includes a composite terminal, an S video terminal, a D terminal, a component terminal, an analog RGB terminal, a DVI-I terminal, a DVI-D terminal, or an HDMI (registered trademark) terminal. In a case in which the image input unit 130 receives an analog image signal, the image input unit 130 converts the received analog image signal to a digital image signal. The image input unit 130 then transmits the converted digital image signal to the image processing unit 140.

The recording/reproduction unit 131 reproduces still image data and video image data from a recording medium 132 and receives still image data and video image data of an image and a video obtained from the image capturing unit 192 from the CPU 110 to record the data in the recording medium 132. The recording/reproduction unit 131 may also record still image data and video image data received from the communication unit 180 in the recording medium 132. The recording/reproduction unit 131 includes an interface for electric connection to the recording medium 132 and a microprocessor for communication with the recording medium 132, for example. Also, the recording/reproduction unit 131 may not necessarily include a dedicated microprocessor, but the CPU 110 may execute similar processing to that of the recording/reproduction unit 131 by means of a program stored in the ROM 111. The recording medium 132 can record still image data, video image data, control data required for the projector 100, and the like. The recording medium 132 may be any type of recording medium such as a magnetic disk, an optical disk, and a semiconductor memory. The recording medium 132 may be a detachable or built-in recording medium.

The image processing unit 140 is configured to provide an image signal received from the image input unit 130 with processing of changing the number of frames, the number of pixels, an image shape, and the like and transmit the signal to the liquid crystal control unit 150 and includes a microprocessor for image processing, for example. The image processing unit 140 may not necessarily include a dedicated microprocessor, but the CPU 110 may function as the image processing unit 140 by means of a program stored in the ROM 111. Meanwhile, the image processing unit 140 can fulfill functions such as frame thinning processing, frame interpolation processing, resolution change processing, and distortion correction processing (keystone correction processing). Also, the image processing unit 140 can perform the aforementioned various processing to an image or a video reproduced by the CPU 110 as well as the image signal received from the image input unit 130.

The liquid crystal control unit 150 controls voltage to be applied to liquid crystal in pixels of the liquid crystal elements 151R, 151G, and 151B based on an image signal processed in the image processing unit 140 to adjust transmittance of the liquid crystal elements 151R, 151G, and 151B. The liquid crystal control unit 150 includes a microprocessor for control, for example. The liquid crystal control unit 150 may not necessarily include a dedicated microprocessor, but the CPU 110 may function as the liquid crystal control unit 150 by means of a program stored in the ROM 111.

In a case in which an image signal is input into the image processing unit 140, the liquid crystal control unit 150 controls the liquid crystal elements 151R, 151G, and 151B so that, each time the liquid crystal control unit 150 receives a one-frame image from the image processing unit 140, the transmittance of the liquid crystal elements 151R, 151G, and 151B may correspond to the image. The liquid crystal element 151R is a liquid crystal element corresponding to a red color. The liquid crystal element 151R corresponds to red light out of red light (R), green light (G), and blue light (B) into which light output from the light source 161 has been separated in the color separation unit 162, and the transmittance of the red light is adjusted by the liquid crystal control unit 150. The liquid crystal element 151G is a liquid crystal element corresponding to a green color. The liquid crystal element 151G corresponds to green light out of red light (R), green light (G), and blue light (B) into which light output from the light source 161 has been separated in the color separation unit 162, and the transmittance of the green light is adjusted by the liquid crystal control unit 150. The liquid crystal element 151B is a liquid crystal element corresponding to a blue color. The liquid crystal element 151B corresponds to blue light out of red light (R), green light (G), and blue light (B) into which light output from the light source 161 has been separated in the color separation unit 162, and the transmittance of the blue light is adjusted by the liquid crystal control unit 150. Specific operations of the liquid crystal control unit 150 for controlling the liquid crystal elements 151R, 151G, and 151B and configurations of the liquid crystal elements 151R, 151G, and 151B will be described below.

The light source control unit 160 is configured to perform on/off control of the light source 161 and light amount control and includes a microprocessor for control. The light source control unit 160 may not necessarily include a dedicated microprocessor, but the CPU 110 may function as the light source control unit 160 by means of a program stored in the ROM 111.

The light source 161 outputs light for projecting an image on the screen 300. Examples of the light source 161 are a halogen lamp, a xenon lamp, and a high-pressure mercury lamp.

The color separation unit 162 is configured to separate light output from the light source 161 into red light (R), green light (G), and blue light (B) and includes a dichroic mirror, a prism, and the like, for example. The color separation unit 162 supplies separated light to the liquid crystal elements 151R, 151G, and 151B. As for the light of respective colors supplied to the liquid crystal elements 151R, 151G, and 151B, the amount of the light passing through each pixel of each liquid crystal panel is restricted. Meanwhile, in a case in which LEDs corresponding to the respective colors are used as the light source 161, the color separation unit 162 is not required.

The color synthesizing unit 163 is configured to synthesize red light (R), green light (G), and blue light (B) passing through the liquid crystal elements 151R, 151G, and 151B and includes a dichroic mirror, a prism, and the like, for example. Light into which the red light (R) component, the green light (G) component, and the blue light (B) component are synthesized by the color synthesizing unit 163 is transmitted to the projection optical system 171. At this time, the liquid crystal elements 151R, 151G, and 151B are controlled by the liquid crystal control unit 150 so that the light transmittance of the liquid crystal elements 151R, 151G, and 151B may correspond to an image input from the image processing unit 140. Thus, when the synthesized light synthesized by the color synthesizing unit 163 is projected on the screen 300 by the projection optical system 171, an image corresponding to the image input from the image processing unit 140 is displayed on the screen 300.

The optical system control unit 170 controls the projection optical system 171 so that the projection optical system 171 may project the first projection image based on the first input image data and the second projection image based on the second input image data on the screen 300. The optical system control unit 170 includes a microprocessor for control. The optical system control unit 170 may not necessarily include a dedicated microprocessor, but the CPU 110 may function as the optical system control unit 170 by means of a program stored in the ROM 111.

The projection optical system 171 projects the synthesized light corresponding to the image processed in the image processing unit 140 on the screen 300. The projection optical system 171 includes a plurality of lenses and an actuator for actuating the lenses and can perform enlargement, shrinking, focusing, and the like of a projected image by actuating the lenses by means of the actuator.

The communication unit 180 is a communication interface configured to transmit/receive a control signal, still image data, video image data, and the like to/from the projector 200. The communication unit 180 also transmits/receives set contents relating to the multiple projection unit 141, the plural input processing unit 142, and the display region changing unit 143 described below to/from the projector 200. Examples of the communication unit 180 are a wireless LAN, a wired LAN, a USB, and Bluetooth (registered trademark). A communication method of the communication unit 180 is not particularly limited. In a case in which a terminal of the image input unit 130 is the HDMI terminal, the communication unit 180 may include an interface configured to perform a CEC communication via the terminal.

The display control unit 190 is configured to control the display unit 191 provided in the projector 100 to cause the display unit 191 to display thereon an image of an operation screen, a switch icon, and the like for operations of the projector 100 and includes a microprocessor for display control. The display control unit 190 may not necessarily include a dedicated microprocessor, but the CPU 110 may function as the display control unit 190 by means of a program stored in the ROM 111.

The display unit 191 displays thereon the operation screen and the switch icon for operations of the projector 100. The display unit 191 may be any device as long as the device can display an image. Examples of the display unit 191 are a liquid crystal display, a CRT display, an organic EL display, and an LED display. The display unit 191 may turn on a light emitting element such as an LED corresponding to a specified button to let the user recognize the button.

The image capturing unit 192 captures a periphery of the projector 100 and obtains an image signal. The image capturing unit 192 can capture an image projected via the projection optical system 171 by capturing an image in a direction to the screen 300. The image capturing unit 192 transmits the captured image and video to the CPU 110, and the CPU 110 temporarily stores the image and the video in the RAM 112 and converts the image and the video into still image data and video image data based on a program stored in the ROM 111. The image capturing unit 192 includes a lens for obtaining an optical image of an object, an actuator for actuating the lens, a microprocessor for controlling the actuator, an image capturing element for converting the optical image obtained via the lens into an image signal, an AD converter for converting the image signal obtained from the image capturing element into a digital signal, and the like. The image capturing unit 192 may capture an image not only in the screen direction but also in a direction to a viewing audience, which is an opposite direction of the screen direction.

Next, the multiple projection unit 141, the plural input processing unit 142, and the display region changing unit 143 that provide characteristic functions of the present embodiment will be described. The multiple projection unit 141, the plural input processing unit 142, and the display region changing unit 143 are operated based on control of the CPU 110 serving as a control unit.

The multiple projection unit 141 executes processing required when the projector 100 projects one image in cooperation with the projector 200. For example, the multiple projection unit 141 executes processing of adjusting brightness of the blending region, in which an image projected by the projector 100 overlaps with an image projected by the projector 200, when the CPU 110 issues a command for brightness adjustment processing.

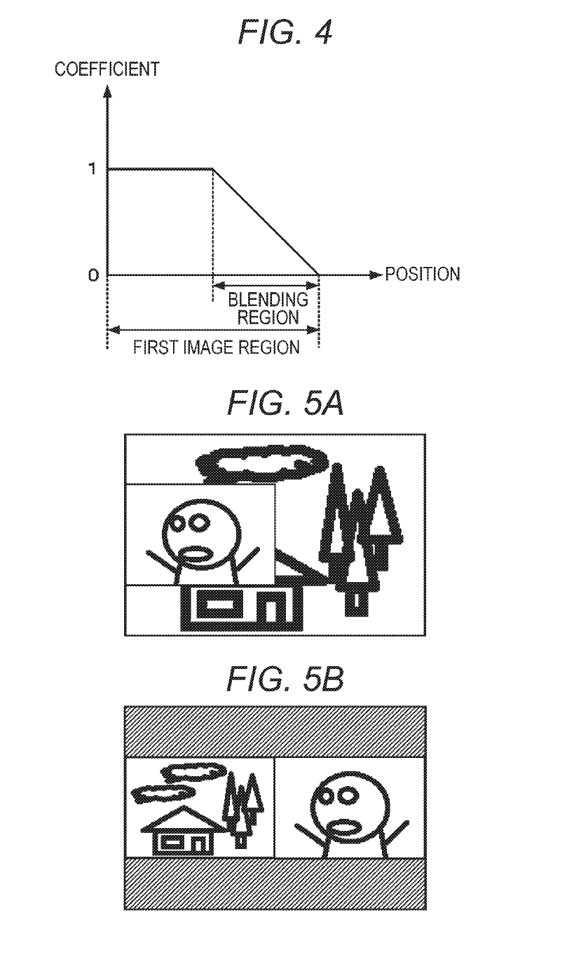

FIG. 4 illustrates an example of a brightness adjustment coefficient to be used when the multiple projection unit 141 executes processing required for multiple projection. In FIG. 4, a horizontal axis represents a position in a horizontal direction in the first image region, which is a projection region of the projector 100 illustrated in FIG. 1, and a vertical axis represents the brightness adjustment coefficient.

The multiple projection unit 141 provides image data corresponding to the blending region, which is a part of the first image region projected by the projector 100 illustrated in FIG. 1 overlapping with the second image region projected by the projector 200, with the brightness adjustment processing with use of a correction coefficient illustrated by the curve in FIG. 4. The brightness adjustment coefficient is not limited to one illustrated by the curve in FIG. 4 as long as the brightness adjustment coefficient is one that makes the brightness level of the blending region, at the time of projecting a totally white image when the image A1 projected on the first image region and the image A2 projected on the second image region overlap with each other, equal to the brightness level of a non-blending region. The multiple projection unit 141 executes edge blending processing of setting a width and a position of the blending region, as well as the brightness adjustment processing.

The plural input processing unit 142 executes processing for performing picture-in-picture display or picture-out-picture display when a plurality of images are input into the projector 100. When a second or subsequent image is input, the plural input processing unit 142 can project the first projection image that the projector 100 is currently projecting and the second projection image that is a second input image simultaneously. Whether the images are to be projected in a picture-in-picture display style or in a picture-out-picture display style is designated by the user via the operation unit 120. When the plurality of images are to be projected simultaneously, the plural input processing unit 142 shrinks the images in accordance with a shrinking ratio of the plurality of input images or a display ratio for a display resolution of each image preset by the user via the operation unit 120.

FIGS. 5A and 5B illustrate the picture-in-picture display style and the picture-out-picture display style. The picture-in-picture display style is a display style in which a second input image is superimposed on a first input image serving as a parent image, as illustrated in FIG. 5A. The picture-out-picture display style is a display style in which the first input image and the second input image are displayed side by side as illustrated in FIG. 5B.

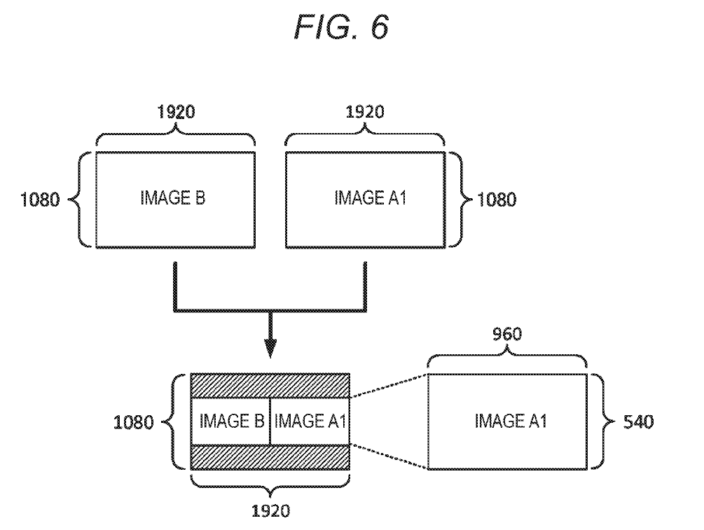

FIG. 6 illustrates the picture-out-picture image. Here, the display resolution is 1920×1080, and two images, the image A1 and the image B as illustrated in FIG. 1, are input into the projector 100. At this time, in a case in which a display ratio between the image A1 and the image B is set to 50:50, the plural input processing unit 142 shrinks the images so that the display resolution of each of the image A1 and image B may be reduced to 960×540 and arranges the shrunk images. The plural input processing unit 142 arranges the shrunk images at positions set by the user via the operation unit 120.

In a case in which the edge blending processing is performed in the multiple projection mode by the multiple projection unit 141, the plural input processing unit 142 determines a position of the image B in accordance with a position of the blending region. In a case in which, while the projector 100 is projecting the image A1 in the multiple projection mode, in which the projector 100 projects the image A in cooperation with the projector 200, the projector 100 moves to a state of projecting the image A1 and the image B simultaneously, the plural input processing unit 142 causes the projector 100 to project the image B in a part of a region on which the projection unit is projecting the image A1 not edge-blended with the image A2 projected by the projector 200. For example, the plural input processing unit 142 causes the projector 100 to project the image B in a part of the first image region on which the projector 100 is projecting the image A1 away from the edge blending region. In this manner, since the image B is not arranged between the image A1 and the image A2, the image A1 and the image A2 that the projector 100 and the projector 200 are projecting in cooperation with each other can be prevented from being separated.

Meanwhile, the layout of the image may be controlled in a device outside the projector 100 without causing the plural input processing unit 142 to generate the picture-in-picture image or the picture-out-picture image. For example, the input device 401 and the input device 402 may input image signals to the projector 100 and the projector 200 and generate the picture-in-picture image or the picture-out-picture image. In this case, the projector 100 and the projector 200 project the picture-in-picture image or the picture-out-picture image obtained from the input device 401 and the input device 402.

In a case in which, while an image obtained by shrinking the image A1 and an image obtained by shrinking the image B are being projected in the picture-out-picture display style in the lone projection mode, the set mode is changed to the multiple projection mode by the user, the display region changing unit 143 cancels shrinking processing that the image A1 has undergone and enlarges the image A1. For example, the display region changing unit 143 trims and rescales the image A1. For example, the display region changing unit 143 sets the width in the horizontal direction of a region on which the image A1 is projected when the image B is being projected to be shorter than the width in the horizontal direction of a region on which the image A1 is projected when the image B is not being projected. In a case in which a second image is input while a first image is being projected in the multiple projection mode, the display region changing unit 143 projects the image A1 to be larger in size than in a case in which the image A1 and the image B are projected in the lone projection mode as described above. In this manner, in the multiple projection mode, the display region changing unit 143 arranges a first image and a second image in a different layout from that of a plurality of images in the lone projection mode.

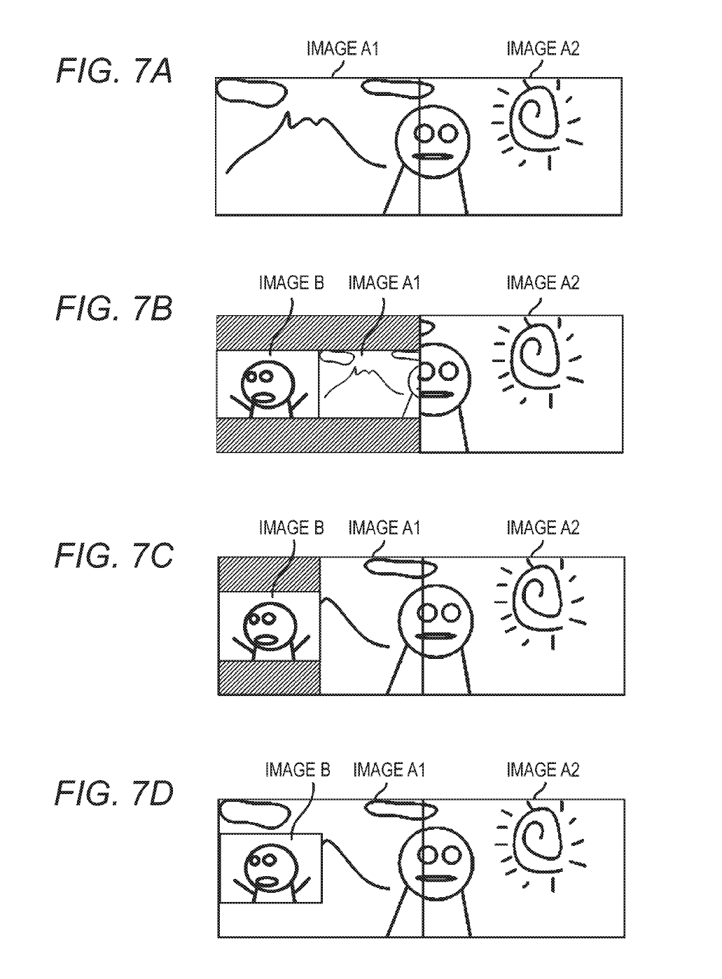

FIGS. 7A to 7D illustrate operations of the display region changing unit 143. The projector 100 and the projector 200 are projecting the image A1 and the image A2 in a multiple manner as described in FIG. 7A. In this state, the image B is input into the projector 100. In this case, when only the image A1 is shrunk for the picture-out-picture display in a similar manner to that in the lone projection mode as illustrated in FIG. 7B, the image A1 and the image A2 will differ in size, and the positional relationship between the image A1 and the image A2 will collapse. Thus, the images will not be displayed correctly. To avoid this, the projector 100 does not perform shrinking processing of the image A1 in the case of the multiple projection mode and in the case of the picture-out-picture display even when the image B is input.

The display region changing unit 143 performs the shrinking processing to the image B to display the image B and trims a display range of the image A1 as much as a display range of the image B in the horizontal direction as illustrated in FIG. 7C. Specifically, in a case in which the display resolution is 1920×1080, and in which the display ratio between the image A1 and the image B is set to 50:50, the display region changing unit 143 sets the display resolution of each of the image A1 and image B to 960×1080. The display region changing unit 143 scales the image B so that the display resolution thereof may be reduced to 960×1080 and trims the image A1 into size of 960×1080. At this time, the display region changing unit 143 trims the image A1 into size of 960×1080 from a side of the image A1 contacting the image A2.

In a case in which the display method for displaying two images is set to the picture-in-picture display style, the display region changing unit 143 changes the resolution of the image B in accordance with a shrinking ratio of the picture-in-picture image set by the user via the operation unit 120 as illustrated in FIG. 7D. The display region changing unit 143 arranges the image B so as to superimpose the image B on the image A1 in a part of a region on which the image A1 is being projected not edge-blended with the image A2. The display region changing unit 143 does not cause the image B to be projected on the edge blending region to prevent the brightness of the image B from being non-uniform. Meanwhile, the display region changing unit 143 may arrange the image B in a position set by the user.

[Basic Operations of Projector 100]

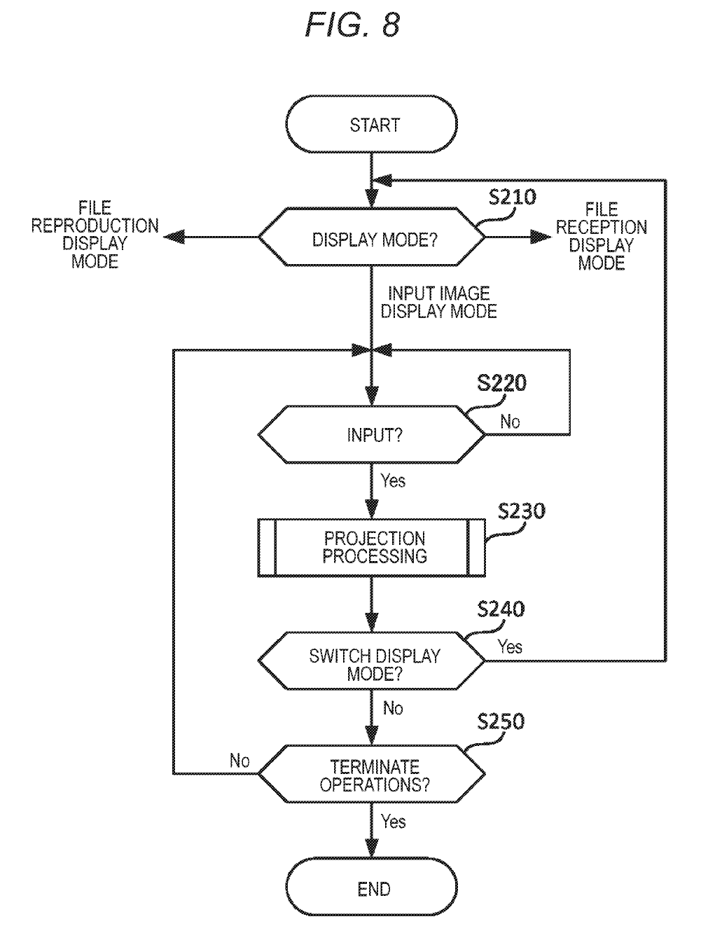

Next, basic operations of the projector 100 according to the present embodiment will be described with reference to FIG. 8.

FIG. 8 is a flowchart illustrating basic operations of the projector 100. The CPU 110 controls the respective functional blocks based on a program stored in the ROM 111 to cause the operations illustrated in FIG. 8 to be executed. The flowchart illustrated in FIG. 8 starts when the user instructs the projector 100 to move to an on state of a power supply thereof via the operation unit 120 or the remote control unit (not illustrated).

When the user instructs turning-on of the power supply of the projector 100 via the operation unit 120 or the remote control unit, the CPU 110 starts supplying electric power to respective parts of the projector 100 from a power supply unit. Subsequently, in S210, the CPU 110 determines a display mode selected by the user through operations of the operation unit 120 or the remote control unit.

One of the display modes of the projector 100 is an “input image display mode” for displaying an image input from the image input unit 130. Another one of the display modes of the projector 100 is a “file reproduction display mode” for displaying an image and a video of still image data and video image data read out from the recording medium 132 by the recording/reproduction unit 131. Still another one of the display modes of the projector 100 is a “file reception display mode” for displaying an image and a video of still image data and video image data received from the communication unit 180. Meanwhile, although a case in which the display mode is selected by the user is described in the present embodiment, the display mode when the power supply is turned on may be a display mode when a previous projection operation is terminated, or any of the aforementioned display modes may be a default display mode. In this case, the processing in S210 can be omitted.

Hereinbelow, operations in a case in which the “input image display mode” has been selected in S210 will be described.

When the “input image display mode” is selected, the CPU 110 determines in S220 whether or not an image is input from the image input unit 130. In a case in which no image is input (No in S220), the CPU 110 stands by until input of an image is detected. In a case in which an image is input (Yes in S220), the CPU 110 executes projection processing in S230.

In the projection processing in S230, the CPU 110 transmits the image input from the image input unit 130 to the image processing unit 140, causes the image processing unit 140 to execute processing of changing the number of pixels, a frame rate, and a shape of the image, and causes the image processing unit 140 to transmit the one-screen image subjected to the changing processing to the liquid crystal control unit 150. The CPU 110 then causes the liquid crystal control unit 150 to control the liquid crystal elements 151 so that the transmittance of the liquid crystal elements 151R, 151G, and 151B may correspond to tone levels of respective color components of the red color (R), the green color (G), and the blue color (B) of the received one-frame image. The CPU 110 also causes the light source control unit 160 to control output of light from the light source 161. This projection processing is sequentially executed per one-frame image while the projector 100 is projecting images. At this time, when a user's instruction for operating the projection optical system 171 is input via the operation unit 120, the CPU 110 causes the optical system control unit 170 to control the actuator of the projection optical system 171 for changes of a focus of the projected image and changes of an enlargement ratio of the optical system.

During execution of the projection processing, the CPU 110 determines in S240 whether or not an instruction for switching the display mode has been input by the user via the operation unit 120. In a case in which the instruction for switching the display mode is input by the user via the operation unit 120 (Yes in S240), the CPU 110 returns to S210 again and performs determination of the display mode. At this time, the CPU 110 transmits a menu screen for selection of a display mode as an OSD image to the image processing unit 140 and controls the image processing unit 140 so that the image processing unit 140 may superimpose this OSD image on the image that is being projected. The user can look at the projected OSD image and select a display mode.

On the other hand, during execution of the projection processing, in a case in which the instruction for switching the display mode is not input by the user via the operation unit 120 (No in S240), the CPU 110 determines in S250 whether or not an instruction for terminating projection has been input by the user via the operation unit 120. In a case in which the instruction for terminating projection has been input by the user via the operation unit 120 (Yes in S250), the CPU 110 stops supplying electric power to the respective blocks of the projector 100 to terminate image projection.

On the other hand, in a case in which the instruction for terminating projection is not input by the user via the operation unit 120 (No in S250), the CPU 110 returns to S220 and repeats processing from S220 to S250 until the instruction for terminating projection is input by the user via the operation unit 120.

The projector 100 projects images on the screen 300 in the above procedure.

Meanwhile, in the “file reproduction display mode,” the CPU 110 causes the recording/reproduction unit 131 to read out a file list of still image data and video image data or thumbnail data of each file from the recording medium 132 and temporarily stores the data in the RAM 112. Based on a program stored in the ROM 111, the CPU 110 then generates a character image based on the file list or an image based on the thumbnail data of each file temporarily stored in the RAM 112 and transmits the image to the image processing unit 140. The CPU 110 then controls the image processing unit 140, the liquid crystal control unit 150, and the light source control unit 160 in a similar manner to that of the normal projection processing (S230).

When an instruction for selecting a character image or an image corresponding to each of still image data and video image data recorded in the recording medium 132 is input via the operation unit 120, the CPU 110 controls the recording/reproduction unit 131 so that the recording/reproduction unit 131 may read out the selected still image data or video image data from the recording medium 132. The CPU 110 then causes the RAM 112 to temporarily store the read still image data or video image data and reproduces an image or video of the still image data or video image data based on a program stored in the ROM 111.

The CPU 110 sequentially transmits, e.g., the reproduced video of the video image data to the image processing unit 140 and controls the image processing unit 140, the liquid crystal control unit 150, and the light source control unit 160 in a similar manner to that of the normal projection processing (S230). In a case of reproducing the still image data, the CPU 110 transmits still image data reproduced to the image processing unit 140 and controls the image processing unit 140, the liquid crystal control unit 150, and the light source control unit 160 in a similar manner to that of the normal projection processing (S230).

Also, in the “file reception display mode,” the CPU 110 temporarily stores still image data or video image data received from the communication unit 180 in the RAM 112 and reproduces an image or video of the still image data or video image data based on a program stored in the ROM 111. The CPU 110 sequentially transmits, e.g., the video of the video image data reproduced to the image processing unit 140 and controls the image processing unit 140, the liquid crystal control unit 150, and the light source control unit 160 in a similar manner to that of the normal projection processing (S230).

[Processing in Multiple Projection]

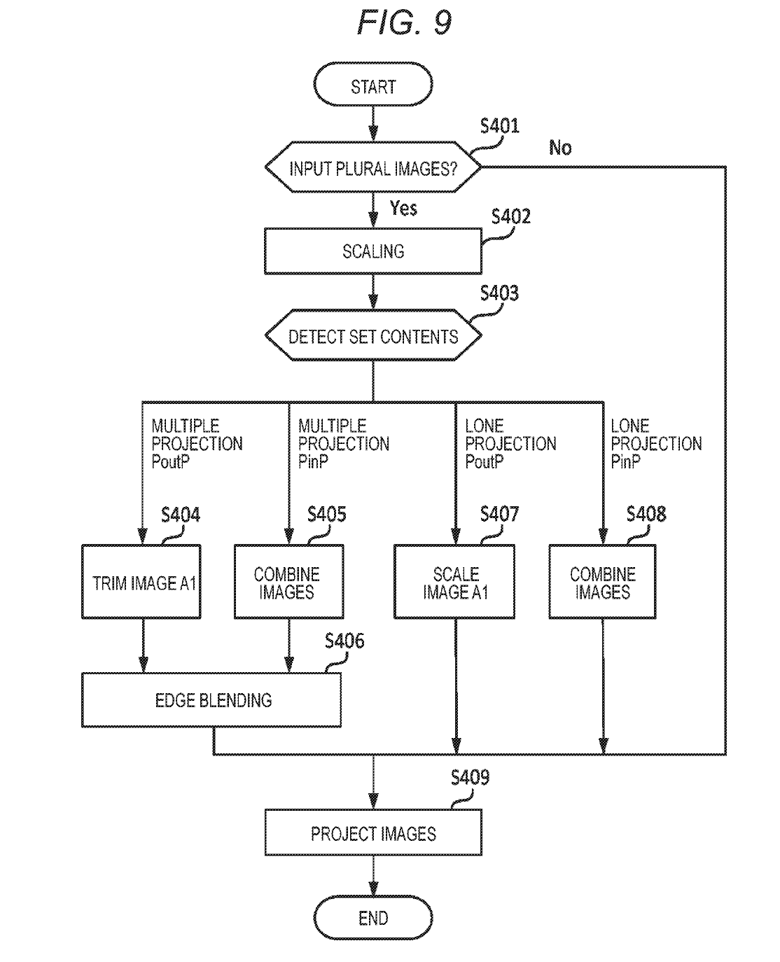

Next, characteristic operations of the projector 100 will be described in detail with reference to the flowchart in FIG. 9. FIG. 9 is a flowchart illustrating operations at the time of multiple projection. Operations in the flowchart in FIG. 9 start when an instruction of power-on is provided via the operation unit 120, and the multiple projection mode is then set. Meanwhile, although operations of the projector 100 will be described below, operations of the projector 200 are similar to those of the projector 100.

First, the CPU 110 determines in S401 whether or not plural images are input into the image input unit 130. In a case in which the CPU 110 determines that plural images are input (Yes in S401), the CPU 110 moves to S402. In a case in which the CPU 110 determines that plural images are not input (No in S401), the CPU 110 moves to S409.

Subsequently, in S402, the CPU 110 scales the image B by controlling the plural input processing unit 142. The size of the image B scaled by the plural input processing unit 142 is preset in the plural input processing unit 142 by an instruction input by the user via the operation unit 120, for example.

Subsequently, in S403, the CPU 110 detects a setting status of the display mode of the plural images. Specifically, the CPU 110 detects which display mode is set, the picture-in-picture display setting or the picture-out-picture display setting. The set contents of the display mode can be input by the user via the operation unit 120, and the input set contents are stored in the ROM 111. The CPU 110 can detect the display mode by referring to the set contents stored in the ROM 111.

The CPU 110 also detects whether the multiple projection mode is set. Whether the multiple projection mode or the lone projection mode is set can be input by the user via the operation unit 120, and the input set contents are stored in the ROM 111. The CPU 110 can detect the projection mode by referring to the set contents stored in the ROM 111.

The CPU 110 moves to one of four processing operations in accordance with combination of the projection mode and the display mode. In a case in which the multiple projection mode and the picture-out-picture display mode (PoutP) are set, the CPU 110 moves to processing in S404. In a case in which the multiple projection mode and the picture-in-picture display mode (PinP) are set, the CPU 110 moves to processing in S405. In a case in which the lone projection mode and the picture-out-picture display mode are set, the CPU 110 moves to processing in S407. In a case in which the lone projection mode and the picture-in-picture display mode are set, the CPU 110 moves to processing in S408.

Meanwhile, in a case in which other projectors are installed on the upper, lower, right, and left sides of the projector 100, and in which the blending regions exist on the upper, lower, right, and left sides, the image B will overlap with any of the blending regions when images are displayed in the picture-out-picture display method. In this case, the CPU 110 may move to S405, not S404, by activating the picture-in-picture display mode, even when the picture-out-picture display mode is being set. At this time, CPU 110 may issue a warning that notifies that the picture-in-picture display mode is to be activated.

In the case of the multiple projection mode and the picture-out-picture display mode (S404), the CPU 110 controls the plural input processing unit 142 so that shrinking processing of the image A may be canceled. The CPU 110 also controls the display region changing unit 143 so that a region in the image A1 for displaying the image B may be deleted and trimmed. The display region changing unit 143 performs trimming by deleting image data in a partial region in the image A1 located on the opposite side of the image A2, not deleting image data of the image A1 located on a side contacting the image A2. In a state in which a part of the image A1 and a part of the image A2 overlap with each other in the blending region, the image B is arranged in a position not overlapping with the blending region.

In the case of the multiple projection mode and the picture-in-picture display mode (S405), the CPU 110 controls the plural input processing unit 142 so that resolution change for the image B may be performed in accordance with a shrinking ratio of the picture-in-picture image set by the user via the operation unit 120. The CPU 110 also controls the plural input processing unit 142 so that the image B subjected to the resolution change may be arranged in the image A1 in accordance with a position of the picture-in-picture image set by the user via the operation unit 120 as illustrated in FIG. 7D.

In the case of the multiple projection mode, the CPU 110 detects after executing the processing in S404 or S405 whether or not the edge blending processing is set. In a case in which the CPU 110 detects that the edge blending processing is set, the CPU 110 controls the plural input processing unit 142 in S406 so that image data in the blending region of the projected image may be adjusted based on the brightness adjustment coefficient illustrated in FIG. 4.

In the case of the lone projection mode and the picture-out-picture display mode (S407), the CPU 110 controls the plural input processing unit 142 so that the image A1 and the image B arranged in the projection screen may be generated by scaling the input image B in accordance with a display ratio set by the user as illustrated in FIG. 5B.

In the case of the lone projection mode and the picture-in-picture display mode (S408), the CPU 110 executes similar processing to that in S405.

The CPU 110 causes the projector 100 to execute processing in S406 to S408, controls the respective components, and projects images (S409). Consequently, the projection processing is completed.

[Effect of First Embodiment]

As described above, in the projector 100 according to the first embodiment, in a case of transition from a state of projecting the image A serving as the first projection image to a state of projecting the image A and the image B serving as the second projection image simultaneously, the CPU 110 performs control so that the image A and the image B may be projected in different layouts from each other depending on whether the transition is one from a state of projecting the image A to a state of projecting the image A and the image B simultaneously by means of the projector 100 alone or one from a state of projecting the image A to a state of projecting the image A and the image B simultaneously by means of the projector 100 in cooperation with the projector 200.

For example, in the case of the transition from the state of projecting the image A to the state of projecting the image A and the image B simultaneously by means of the projector 100 alone, the CPU 110 projects the image A and the image B with a width of each image shorter than a width of the projection region in a vertical direction. Conversely, in the case of the transition from the state of projecting the image A to the state of projecting the image A and the image B simultaneously by means of the projector 100 in cooperation with the projector 200, the CPU 110 projects the image A with a width thereof equal to the width of the projection region in the vertical direction and projects the image B with a width thereof shorter than the width of the projection region in the vertical direction. This can prevent the image A being projected by the projector 100 in cooperation with the projector 200 from being separated at a boundary between the projection region of the projector 100 and the projection region of the projector 200, and images can be projected appropriately.

<Second Embodiment>

In the first embodiment, when the projector 100 needs to project the image B in the multiple projection mode, the projector 100 keeps the width of the image A1 in the vertical direction that the projector 100 is projecting in cooperation with the projector 200 equal to the width of the image A2 in the vertical direction that the projector 200 is projecting and deletes the partial region in the image A1 located on the opposite side of the side on which the projector 200 projects an image. On the other hand, a second embodiment differs from the first embodiment in that, when the projector 100 needs to project the image B, the projector 200 changes a width of the image A2 in the vertical direction that the projector 200 projects. The projector 200 changes a size of the image A2 to one based on an image size in the picture-out-picture display in the projector 100.

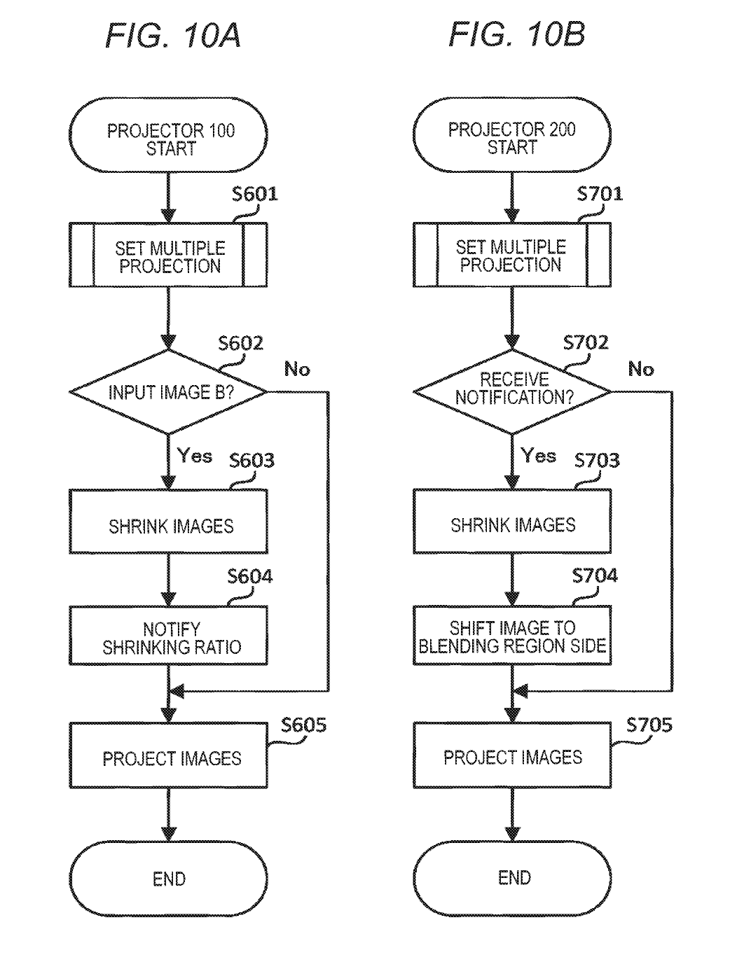

FIGS. 10A and 10B are flowcharts illustrating operations of the projector 100 and the projector 200 in the second embodiment, respectively. Hereinbelow, with reference to the flowcharts in FIGS. 10A and 10B, a method for adjusting a shrinking ratio of the projected image of the projector 200 based on a shrinking ratio of the projected image of the projector 100 that is displaying two screen images will be described. FIG. 10A is a flowchart for the projector 100. FIG. 10B is a flowchart for the projector 200.

In the present embodiment, description will be provided, assuming that the picture-out-picture display is set for the projector 100 and the projector 200. It is also assumed that the projector 100 and the projector 200 are connected to each other via the communication unit 180 and respectively perform the edge blending processing. After the projector 100 and the projector 200 are powered on, and a series of initial operations is completed, the image A1 and the image A2 are input from the input device 401 as illustrated in FIG. 1, and operations illustrated in the flowcharts in FIGS. 10A and 10B are started.

First, operations of the projector 100 will be described with reference to the flowchart in FIG. 10A.

In S601, the CPU 110 of the projector 100 controls the multiple projection unit 141 so that processing in the multiple projection mode will be started. Subsequently, in S602, the image input unit 130 detects whether or not the image B has been input from the input device 402 during projection of the image A1 in the multiple projection mode. In a case in which the image B is input, the projector 100 moves to processing in S603. In a case in which the image B is not input, the projector 100 moves to processing in S605.

In S603, the plural input processing unit 142 shrinks the image A1 and the image B based on a display ratio in the picture-out-picture display preset by the user via the operation unit 120. For example, in a case in which the display resolution is set to 1920×1080, and in which the display ratio between a first input image and a second input image is set to 50:50, the plural input processing unit 142 shrinks the images so that the display resolution of each image may be reduced to 960×540. The plural input processing unit 142 shrinks the images while keeping an aspect ratio of each image, for example.

In S604, the plural input processing unit 142 calculates the shrinking ratio of the first input image A1 shrunk in S603 and notifies via the communication unit 180 the projector 200 of the shrinking ratio and layout information indicating a position for projecting the shrunk image A1. For example, as illustrated in FIG. 6, in a case in which the display resolution is 1920×1080, in which the display ratio between a first input image and a second input image is 50:50, and in which the resolution of the image A1 is 1920×1080, the shrinking ratio is 50% since the image A1 is shrunk so that the resolution in the horizontal direction may be reduced to 960×1080. Also, a coordinate of a center position in the vertical direction indicating the position for projecting the image A1 is 540. In this case, the plural input processing unit 142 notifies the projector 200 of shrinking ratio information indicating that the shrinking ratio is 50% and the layout information indicating that the coordinate of the center position of the image A1 in the vertical direction is 540.

In S605, the projector 100 projects the images generated in S603.

Next, operations of the projector 200 will be described with reference to the flowchart in FIG. 10B.

In S701, the CPU 110 of the projector 200 performs similar processing to that in S601 in the flowchart in FIG. 10A. In S702, the CPU 110 of the projector 200 confirms if the notification transmitted in S604 in the flowchart in FIG. 10A is received via the communication unit 180. In a case in which the CPU 110 of the projector 200 has detected that the notification is received, the CPU 110 of the projector 200 moves to processing in S703. In a case in which the CPU 110 of the projector 200 does not receive the notification, the CPU 110 of the projector 200 moves to processing in S705.

In S703, the CPU 110 of the projector 200 controls the image processing unit 140 so that the image A2 may be shrunk in accordance with the notification of the shrinking ratio from the projector 100. For example, in a case in which notification of setting the shrinking ratio to 50% is received, the CPU 110 controls the image processing unit 140 so that the image A2 may be shrunk to 50%.

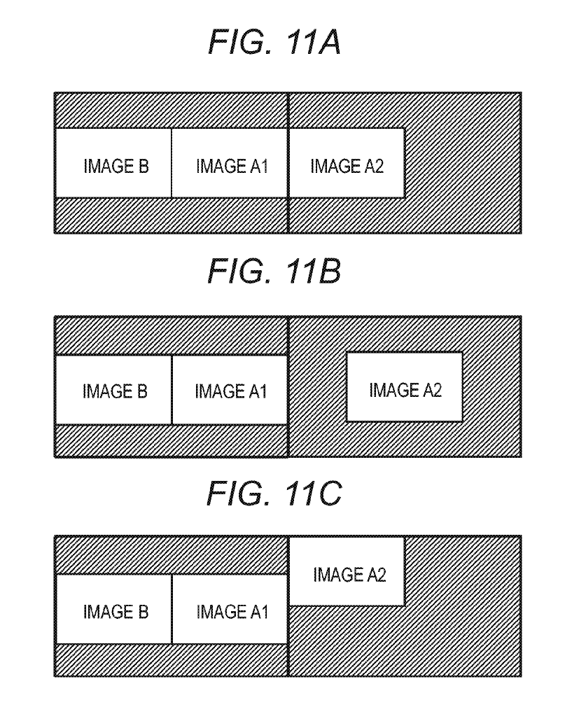

In S704, when the image A2 that the image processing unit 140 has shrunk in S703 is to be projected, the projector 200 generates the projected image A2 located in the projection position indicated in the layout information included in the notification received from the projector 100. FIGS. 11A to 11C illustrate a position in which the projector 200 projects the image A2. For example, in a case in which the image A1 is arranged in a center position in the vertical direction in the projector 100, the projector 200 arranges the image A2 in the center position in the vertical direction in a similar manner to that of the image A1 as illustrated in FIG. 11A. The projector 200 also arranges the image A2 in a position contacting the image A1. This can prevent a state in which the image A1 and the image A2 are not connected appropriately as illustrated in FIG. 11B and FIG. 11C from being generated.

In S705, the projector 200 projects the images generated in S704.

[Modification Example]

When the projector 100 performs the picture-out-picture display, the projector 100 may set the width of the image A1 in the vertical direction that is to be projected in cooperation with the projector 200 to be different from the width of the image B in the vertical direction. For example, the projector 100 determines a shrinking ratio of the image A1 based on an instruction of the user obtained via the operation unit 120 and notifies the determined shrinking ratio to the projector 200. The projector 200 shrinks the image A2 based on the notified shrinking ratio.

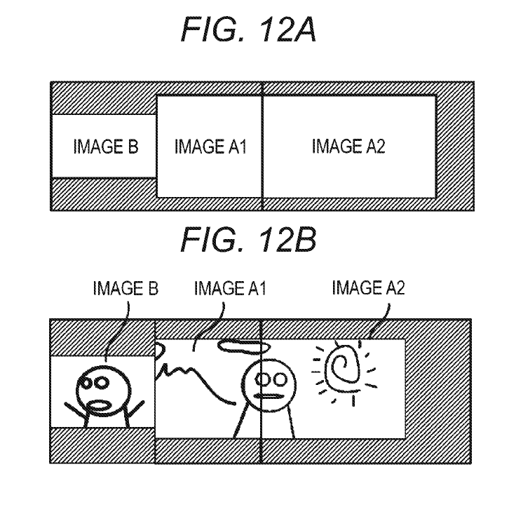

FIGS. 12A and 12B illustrate operations in a modification example. In this case, as illustrated in FIG. 12A, the image A1 and the image A2 are displayed to be larger than in the case illustrated in FIG. 11A. Note that a partial region of the image A1 on a side contacting the image B is trimmed. FIG. 12B illustrates an example of images displayed in this case. Although the image A1 and the image A2 are displayed to be smaller than those in FIG. 7C, the image region displayed in the image A1 is larger than that in FIG. 7C. Thus, according to the modification example, the projector 100 and the projector 200 can project the image A1 and the image A2 to be as large as possible while preventing a region in the image A1 that the user wishes to display from being deleted.

[Effect of Second Embodiment]

As described above, in the second embodiment, even in a case in which the image A1 and the image B are scaled to display the image A1 and the image B in the picture-out-picture display method in the projector 100, the projector 200 changes the shrinking ratio of the image A2 based on the shrinking ratio of the image A1. Accordingly, even in a case in which the shrinking ratio of the image A1 that the projector 100 is to project is determined, the image A1 and the image A2 can be displayed appropriately.

<Third Embodiment>

In the first embodiment, the projector 100 and the projector 200 are connected to the input devices to be parallel to the input devices. A third embodiment differs from the first embodiment in that the projector 100 and the projector 200 are cascade-connected. The cascade connection is multistage connection in which a plurality of devices are connected in series.

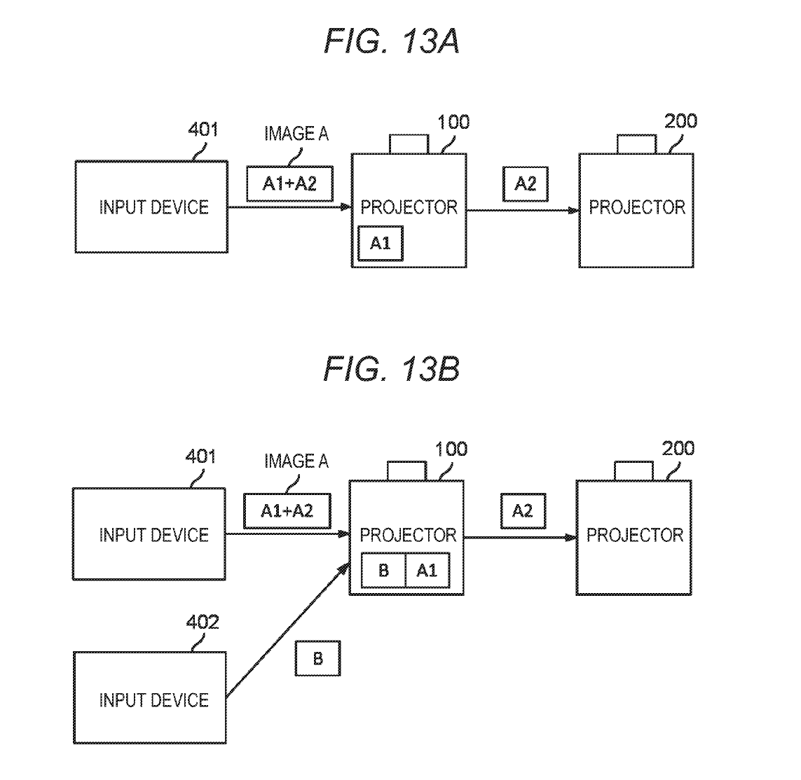

FIGS. 13A and 13B illustrate connection methods of the projector 100 and the projector 200 in the third embodiment. In FIGS. 13A and 13B, the projector 100 is arranged on an upstream side while the projector 200 is arranged on a downstream side. The arrows in FIGS. 13A and 13B indicate directions in which image data flows. The projector 100 divides the image A that the projector 100 and the projector 200 are to project in cooperation into the image A1 that is a region to be projected by the projector 100 and the image A2 that is a region to be projected by the projector 200 and transmits the image A2 to the projector 200. The CPU 110 of the projector 100 divides the image A based on the number and positional relationship of other projectors connected to the projector 100.

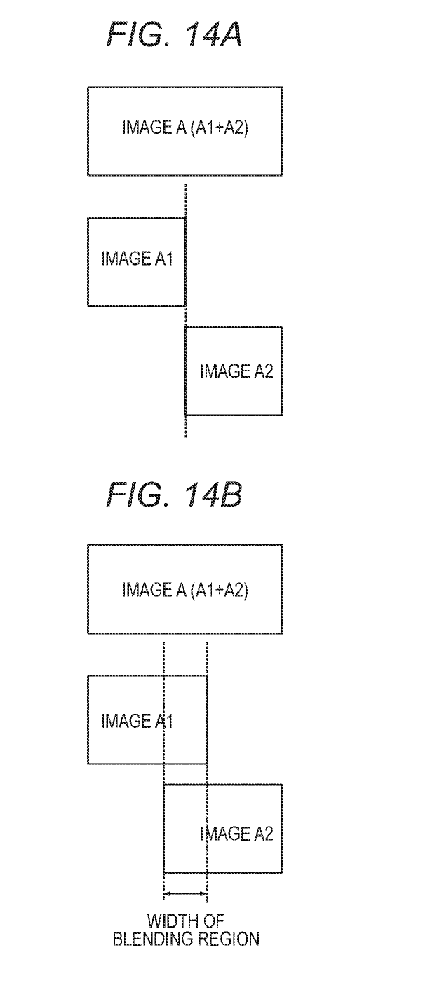

The CPU 110 divides the image A at a position based on set contents of the edge blending processing, for example. FIGS. 14A and 14B illustrate processing for dividing the image A. In a case in which no edge blending processing is performed, the CPU 110 does not provide a blending region and divides the image A at an arbitrary position as illustrated in FIG. 14A. In a case in which the edge blending processing is performed, the CPU 110 divides the image A so that an image in a region indicated by a position and a width of the blending region set in the multiple projection unit 141 may be included both in the image A1 and in the image A2 as illustrated in FIG. 14B.

Also, the CPU 110 determines based on setting set by the user a display layout in a case in which the projector 100 and the projector 200 are cascade-connected. In a case in which the projector 100 is to project the image A1 on the left side of a position in which the projector 200 is to project the image A2, and in which the projector 200 is to project the image A2 on the right side of a position in which the projector 100 is to project the image A1, the CPU 110 divides the image A so that the left-side region of the image A may be the image A1, and so that the right-side region of the image A may be the image A2.

The CPU 110 of the projector 100 communicates via the communication unit 180 with the projector 200 cascade-connected to the projector 100. The CPU 110 transmits information indicating a determined layout and the image A2 generated by dividing the image A to the projector 200, for example.

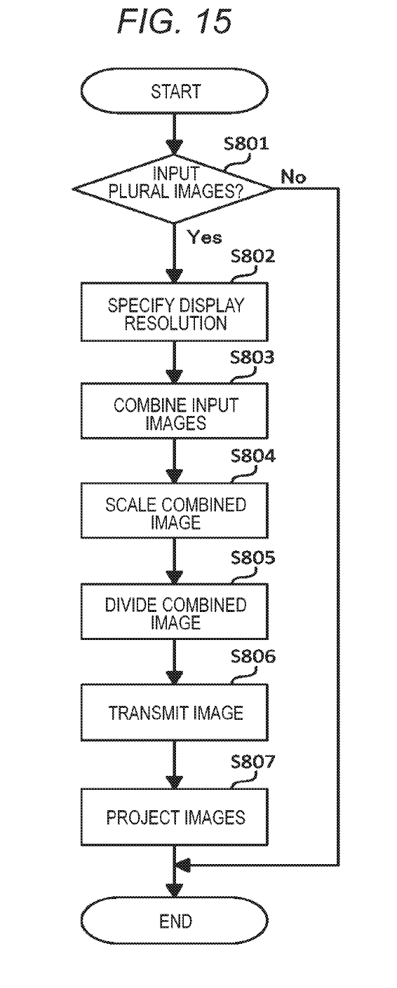

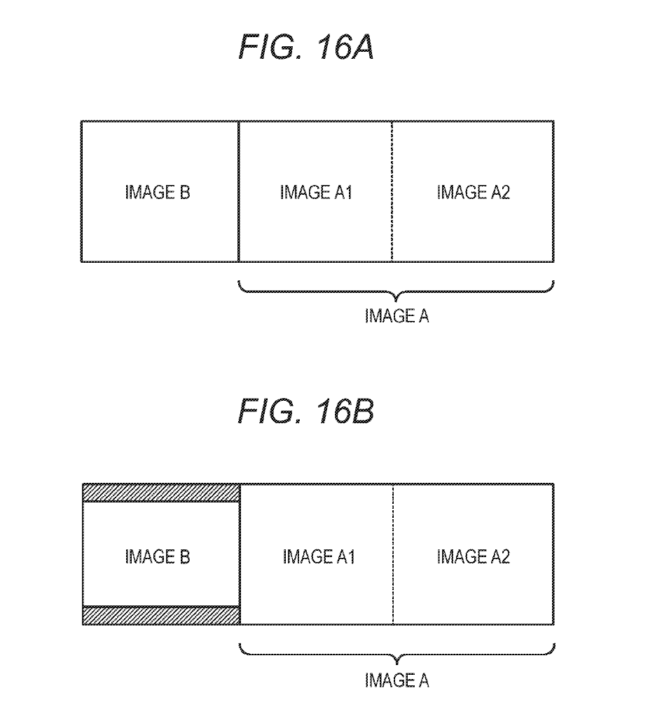

FIG. 15 is a flowchart illustrating operations in which the projector 100 cascade-connected to the projector 200 projects a second input image in the multiple projection mode. FIGS. 16A and 16B illustrate image processing in the third embodiment. Here, it is assumed that the projector 100 is operated in the multiple projection mode, and that the edge blending region is set. It is also assumed that the projector 100 is operated in the picture-out-picture display mode.

After the projector 100 and the projector 200 are powered on, and a series of initial operations is completed, the image A is input from the input device 401 as illustrated in FIG. 13A, and operations in FIG. 15 are started.

Processing in S801 is similar to processing in S401 in the flowchart in FIG. 9. In the present embodiment, the image A and the image B are input into the image input unit 130 as illustrated in FIG. 13B.

In S802, the CPU 110 specifies display resolution of the multiple projection image from a width of the blending region set in the multiple projection unit 141 and resolution of the projectors. The CPU 110 specifies display resolution of the multiple projection image based on resolution of the liquid crystal elements 151 of the projector 100 and resolution of the projector 200 obtained via the communication unit 180, for example. In a case in which the resolution of each of the projector 100 and the projector 200 obtained by the CPU 110 is 1920×1080, and in which the width of the blending region set in the multiple projection unit 141 is 100, resolution in the horizontal direction is 1920×2−100=3740. That is, the display resolution of the multiple projection image in a case in which the projector 100 and the projector 200 project the image A in cooperation is 3740×1080.

In S803, the plural input processing unit 142 combines two input images, the image A and the image B, projected by the projector 100 as illustrated in FIG. 16A. For example, in a case in which the projector 100 projects the image A1 located in a left-side region of the image A, the CPU 110 controls the plural input processing unit 142 so that the second input image B may be arranged on the left side of the image A and combined with the image A.

Meanwhile, the CPU 110 may combine the image A and the image B in parallel in arbitrary positions as long as the second input image B is not located in the blending region. Also, as illustrated in FIG. 16B, in a case in which the image A and the image B are combined in parallel in the horizontal direction and have different resolutions from each other in the vertical direction, the CPU 110 provides the image having smaller resolution in the horizontal direction with an optical black image (a shaded region in FIG. 16B) and performs control so that the resolution of the image B including the optical black image and the resolution of the image A may correspond to each other. The CPU 110 may provide the optical black image in an arbitrary position in the vertical direction as long as the resolution of the image B and the resolution of the image A correspond to each other. The CPU 110 may determine the positions of the image A and the image B to positions in the vertical direction set by the user.

Meanwhile, the CPU 110 may save the aspect ratios of the image A and the image B, and the present disclosure is not limited to this. For example, the CPU 110 may enlarge the image having smaller resolution in the vertical direction so that the resolution of the image having smaller resolution may correspond to the resolution of the image having larger resolution and then combine the plural images.

In S804, the CPU 110 controls the image processing unit 140 and scales the image combined in S803 so that the resolution of the image generated by the plural input processing unit 142 may be the display resolution specified in S802.

In S805, the CPU 110 divides the image A into the image A1 and the image A2 based on set contents of the edge blending processing and layout information indicating positional relationship between the projector 100 and the projector 200 at the time of cascade connection. Since the CPU 110 divides the image A at different positions depending on the resolution of the input images, display ranges of the respective divided images are determined in accordance with the resolution of the input images.

Specifically, in a case in which the resolution of each of the projector 100 and the projector 200 is 1920×1080, and in which the width of the blending region is 100, the display resolution of the image A in a case in which the projector 100 and the projector 200 project the image A in cooperation is 3740×1080. In a case in which an upper left point of the image A is (x, y)=(0, 0), and in which a lower right point thereof is (x, y)=(3739, 1079), the CPU 110 generates the image A1 corresponding to the position of 0 to 1919 of the image A in the horizontal direction and the image A2 corresponding to the position of 1820 to 3739.

In S806, the CPU 110 transmits via the communication unit 180 to the projector 200 the image A2 generated by dividing the image A in S805.

In S807, the projector 100 and the projector 200 project the image A1 and the image A2, respectively.

Meanwhile, in the present embodiment, the projector 100 may not execute processing in S803. The projector 100 may scale the images separately in S804 and display the scaled images in respective predetermined positions.

Also, in the present embodiment, although the case in which the projector 100 and the projector 200 are arranged in the horizontal direction has been described, the number of projectors is arbitrary, and a plurality of projectors may be arranged in the horizontal direction or in the vertical direction. Also, in the present embodiment, although the case in which the projector 100 and the projector 200 are cascade-connected has been described, the connection method is not limited to the cascade connection as long as a plurality of projectors can communicate with each other.

[Effect of Third Embodiment]

As described above, in the present embodiment, the projector 100 divides an image and transmits a part of the divided image to the projector 200. Thus, the input device 401 does not need to generate an image to be projected by the projector 100 and an image to be projected by the projector 200. Accordingly, when the projector 100 in which two images have been input and the projector 200 performs multiple projection of one of the two images, the projector 100 and the projector 200 can perform multiple projection appropriately with use of the input device 401 not having a function of dividing an image.

The present disclosure has been described above based on several embodiments. A new embodiment to be generated by arbitrary combination thereof is included as an embodiment of the present disclosure. The new embodiment to be generated by the combination has both an effect of its own and the effects of the aforementioned embodiments.

Also, the technical range of the present disclosure is not limited to the range described in the above embodiments. It is to be understood by those skilled in the art that various modifications or improvements can be added to the above embodiments. Such modification examples of the embodiments will be described below.

Although an example in which the projection apparatus is a projector has been described above, the projection apparatus is not limited to this. The present disclosure can be applied to an arbitrary apparatus as long as the apparatus can display an image. For example, the projection apparatus can be an apparatus including a screen on which the apparatus itself projects an image such as a liquid crystal television, a liquid crystal display, and an electronic apparatus including a liquid crystal display unit. Also, as for the type of the liquid crystal projector, a single-panel type and a three-panel type are generally known. Either type may be employed.

Also, although a case in which two images are input has been described above, the present disclosure can be applied to a case in which three or more images are input. Also, although the display ratio in the picture-out-picture display is 50:50 in the above description, the display ratio may be an arbitrary value as long as the image A and the image B are arranged in appropriate positions and are smooth in the multiple projection.

Also, although an example in which the CPU 110 of the projector 100 controls a layout of projected images has been described above, a computer such as the input device 401 and the input device 402 may execute a program to perform image processing for controlling the layout of the images projected by the projector 100 and the projector 200 instead of or in cooperation with the CPU 110.

Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-009586, filed Jan. 21, 2016, which is hereby incorporated by reference herein in its entirety.

What is claimed is:

1. A projection apparatus for projecting an image comprising:
a projection unit;
a processor; and
a memory having stored thereon instructions that when executed by the processor, cause the processor to
obtain a first input image and a second input image,
project a first projection image based on the first input image and a second projection image based on the second input image on a screen by means of the projection unit, and
in a case of transition from a state of projecting the first projection image to a state of projecting the first projection image and the second projection image simultaneously, perform control so that the projection unit may project the first projection image and the second projection image in different layouts from each other depending on whether the transition is one from a state of projecting the first projection image to a state of projecting the first projection image and the second projection image simultaneously by means of the projection apparatus alone or one from a state of projecting the first projection image to a state of projecting the first projection image and the second projection image simultaneously by means of the projection apparatus in cooperation with a different projection apparatus.

2. The projection apparatus according to claim 1,
wherein, in the control, the projection unit is caused to project the second projection image in a part of a region on which the projection unit is projecting the first projection image not edge-blended with an image projected by the different projection apparatus.

3. The projection apparatus according to claim 2,
wherein, in the control, in a case in which, while the projection apparatus is projecting the first projection image in a multiple projection mode, in which the projection apparatus projects the first projection image in cooperation with the different projection apparatus, the projection apparatus moves to a state of projecting the first projection image and the second projection image simultaneously, the projection unit is caused to project the second projection image in a part of a region on which the first projection image is being projected away from an edge blending region.

4. The projection apparatus according to claim 1,
wherein setting of whether the projection apparatus is operated in a lone projection mode, in which the projection apparatus projects the first projection image alone, or in a multiple projection mode, in which the projection apparatus projects the first projection image in cooperation with the different projection apparatus, is accepted, and
wherein, in the control, in a case in which, while the first projection image obtained by shrinking the first input image and the second projection image obtained by shrinking the second input image are being projected in the lone projection mode, setting of the multiple projection mode is accepted, the first projection image is enlarged.

5. The projection apparatus according to claim 4,
wherein, in accepting, setting of whether the projection apparatus is operated in a picture-in-picture mode, in which the second projection image is projected to be superimposed on a partial region of the first projection image or in a picture-out-picture mode, in which the second projection image is projected not to be superimposed on the first projection image is accepted, and
wherein, in the control, in a case in which regions edge-blended with an image projected by the different projection apparatus exist in upper, lower, right, and left regions of the first projection image, the picture-in-picture mode is activated even when setting of the picture-out-picture mode is accepted.

6. The projection apparatus according to claim 1,
wherein, in the control, a width in a horizontal direction of a region on which the projection unit projects the first projection image when the projection unit is projecting the second projection image is set to be shorter than a width in the horizontal direction of a region on which the projection unit projects the first projection image when the projection unit is not projecting the second projection image.

7. The projection apparatus according to claim 1,
wherein, in the control, in a part of a region on which the projection unit is projecting the first projection image not edge-blended with an image projected by the different projection apparatus, the second projection image is projected to be superimposed on the first projection image.

8. The projection apparatus according to claim 1,
wherein, in the control, the second projection image generated by shrinking the second input image is projected.

9. The projection apparatus according to claim 1,
wherein, in the control, in a case in which, while the projection apparatus is projecting the first projection image in a multiple projection mode, in which the projection apparatus projects the first projection image in cooperation with the different projection apparatus, the second input image is obtained, the first projection image is shrunk,
the projection apparatus further comprising a communication unit configured to transmit information indicating a shrinking ratio of the first projection image to the different projection apparatus.

10. The projection apparatus according to claim 9,
wherein the communication unit further transmits information indicating a position for projecting the first projection image to the different projection apparatus.

11. The projection apparatus according to claim 1,
wherein, in the control, in a case in which a communication unit receives information indicating a shrinking ratio and information indicating a projection position from the different projection apparatus, the first projection image shrunk at the shrinking ratio is located in a position corresponding to the projection position.

12. The projection apparatus according to claim 1,
wherein, in the control, the first projection image is divided based on a number and positional relationship of the different projection apparatuses that project the first projection image in cooperation.

13. The projection apparatus according to claim 12,
wherein, in the control, the first projection image is divided based on a size of a region in which an image projected by the different projection apparatus and an image projected by the projection unit are edge-blended.

14. A projection method in which a projection apparatus projects an image, comprising:
obtaining a first input image and a second input image;
projecting a first projection image based on the first input image on a screen by means of the projection apparatus;
in a case of transition from a state of projecting the first projection image to a state of projecting the first projection image and a second projection image simultaneously by means of the projection apparatus alone, causing the projection apparatus to project the first projection image and the second projection image in a first layout; and
in a case of transition from a state of projecting the first projection image to a state of projecting the first projection image and the second projection image simultaneously by means of the projection apparatus in cooperation with a different projection apparatus, causing the projection apparatus to project the first projection image and the second projection image in a second layout.

15. A non-transitory storage medium for storing a program configured to cause a computer to execute a below projection method, the projection method comprising:
projecting a first projection image based on a first input image on a screen by means of a projection apparatus;
in a case of transition from a state of projecting the first projection image to a state of projecting the first projection image and a second projection image simultaneously by means of the projection apparatus alone, causing the projection apparatus to project the first projection image and the second projection image in a first layout; and
in a case of transition from a state of projecting the first projection image to a state of projecting the first projection image and the second projection image simultaneously by means of the projection apparatus in cooperation with a different projection apparatus, causing the projection apparatus to project the first projection image and the second projection image in a second layout.
